(19) United States
(12) Patent Application Publication
(10) Pub. No.: US 2017/0295816 A1
(43) Pub. Date: Oct. 19, 2017

(54) 3D FOOD PRINTER

(71) Applicant: KUNSHAN PORIMY 3D PRINTING TECHNOLOGY CO., LTD., Kunshan (CN)

(72) Inventors: Yungan Wang, Kunshan (CN); Tong Chen, Kunshan (CN); Xuan Wang, Shanghai (CN); Wengao Hu, Kunshan (CN); Yulin Zhao, Kunshan (CN); Hao Yin, Kunshan (CN)

(73) Assignee: SHANGHAI FOCHIF ELECTROMECHANICAL TECHNOLOGY CO., LTD., Shanghai (CN)

(21) Appl. No.: 15/323,316

(22) PCT Filed: Aug. 1, 2016
(86) PCT No.: PCT/CN2016/092670

§ 371 Date: Dec. 30, 2016

(30) Foreign Application Priority Data
Apr. 14, 2016 (CN) 201610230221.7

(51) Int. Cl. A23G 1/20; B33Y 30/00; B33Y 80/00; A23G 1/54

(52) U.S. Cl. CPC A23G 1/206; A23G 1/54; B33Y 30/00; B33Y 80/00; A23V 2002/00

(57) ABSTRACT

The present invention discloses a 3D food printer, which comprises a large hopper in a print head with a cooling system, so as to store and supply a large amount of a food material and print reliably at a high ambient temperature, and an automatic conveying system for printed products, so as to automatically output the food product after printing it, and then proceed with the next one. These features make the printer more effective, easier to operate, and in line with the requirements of food hygiene. The technical solution includes: the 3D food printer comprising a print head for extruding a food material; a cooling system for keeping the food material at a low temperature at which the food material does not melt or agglomerate; a conveying system for automatically outputting a printed food product; a frame for supporting the entire 3D food printer; a drive system for driving the 3D food printer to move in the X-, Y- and Z-directions; and a control system for controlling the operation of the entire 3D food printer.

### FIELD OF THE INVENTION

The present invention relates to a 3D printer, in particular to a 3D printer for making food (for example, chocolate).

### BACKGROUND

With the development of 3D printing technology, 3D food printers begin to appear, and particularly there are more and more 3D chocolate printers. However, their structures generally have some defects, which mainly consist in that the material storage device (a syringe, or a hopper) has a small volume, so that frequent supplement is often needed during printing; the chocolate needs to be taken out manually after printing, which is not only complicated in operation and reduces the efficiency, but also disadvantageous for food hygiene; and in hot summer, due to the excessively high ambient temperature, chocolate granules in the hopper may melt and agglomerate, causing the printer unable to work normally.

### SUMMARY

A brief summary on one or more aspects is given below to provide the basic understanding for these aspects. The summary is not an exhaustive review for all the conceived aspects, and is intended to neither point out all the critical or decisive factors for all the aspects nor define the scope of any or all of the aspects. Its only aim is to provide some concepts of one or more aspects in a simplified manner as a preface of the more detailed description given later.

The object of the present invention is to, for solving the above-mentioned problems, provide a 3D food printer, which comprises a large hopper in a print head with a cooling system, so as to store and supply a large amount of a food material and print reliably at a high ambient temperature, and an automatic conveying system for printed products, so as to automatically output the food product after printing it, and then proceed with the next one. These features make the printer more effective, easier to operate, and in line with the requirements of food hygiene.

The technical solution of the present invention is as follows: the present invention discloses a 3D food printer, comprising:

a print head for extruding a food material;

a cooling system for keeping the food material at a low temperature at which the food material does not melt or agglomerate;

a conveying system for automatically outputting a printed food product;

a frame for supporting the entire 3D food printer;

a drive system for driving the 3D food printer to move in the X-, Y- and Z-directions; and

a control system for controlling the operation of the entire 3D food printer.

According to an embodiment of the 3D food printer of the present invention, said print head comprises a first stepper motor, a bevel gear pair, a transmission shaft, a screw, a hopper, a material barrel, a material cover, an electric heating jacket, a cross-shaped plate, a blade, a water jacket and a nozzle, wherein:

for said first stepper motor is horizontally installed on a side of the hopper, an output shaft of the first stepper motor is connected to a small bevel gear in the bevel gear pair, and the base of the first stepper motor is connected to a side of the hopper, for driving the screw;

for said bevel gear pair comprises a small bevel gear and a large bevel gear, the small bevel gear being engaged with the large bevel gear, and the large bevel gear being fixed to an upper end of the transmission shaft, for transferring the motion of the first stepper motor;

for said screw, an upper end of the screw is connected to the transmission shaft, a lower end of the screw is connected to the nozzle, and the outer diameter of the screw is fitted with an inner hole of the material barrel, for conveying and extruding the food material;

for said hopper, an upper end of the hopper is fitted with the material cover, a lower end of the hopper is connected to the material barrel, and a side of the hopper is connected to a base of the first stepper motor, for storing the food material;

for said material barrel, an upper end of the material barrel is connected to the hopper, a lower end of the material barrel is connected to the electric heating jacket, and a middle part of the material barrel is connected to a Z-direction driving mechanism of the drive system, for guiding the screw and transferring the Z-directional motion;

for said material cover, a lower surface of the material cover is fitted with the upper end of the hopper, for closing an upper charging opening of the hopper;

said electric heating jacket comprises an electrical heating rod and a thermocouple, an upper end of the electric heating jacket is connected to the material barrel, and an inner hole of the electric heating jacket is fitted with the nozzle, for heating the food material in the nozzle;

for said cross-shaped plate, an outer edge of the cross-shaped plate is connected to an inner wall of the hopper, and an inner hole of the cross-shaped plate is fitted with the transmission shaft by means of a bearing therein, for locating the transmission shaft;

for said blade, an inner hole of the blade is connected to the transmission shaft, for stirring the food material in the hopper;

for said water jacket, an inner wall of the water jacket is fitted with the outer wall of the hopper, cooling water from the cooling system is circulating in an internal groove in the water jacket, for lowering the temperature of the food material in the hopper; and

for said nozzle, an upper end of the nozzle is connected to the screw, an outer edge of the nozzle is fitted with the inner hole of the electric heating jacket, for transforming the food material into a molten filament and extruding the material onto a cling film of a conveying system therebelow.

According to an embodiment of the 3D food printer of the present invention, the first stepper motor in said print head drives the vertically installed screw by means of the engaged bevel gear pair, so as to prevent the first stepper motor from being perpendicular to the hopper and thus blocking the channel for adding the food material and reducing the storage capacity of the hopper.

According to an embodiment of the 3D food printer of the present invention, the hopper of said print head is cooled by a cooling system comprising a water pump, a cold water tank, a cooling-water machine and water pipes, wherein:

for said water pump, an inlet of the water pump is connected to the cold water tank via the water pipe, and an outlet of the water pump is connected to the cooling-water machine via the water pipe, so that the water in the cold water tank is cooled by the cooling-water machine and flows into the water jacket of the print head;

for said cold water tank, an outlet of the cold water tank is connected to the water pump via the water pipe, an inlet of the cold water tank is connected to the water jacket via the water pipe, and a thermocouple is installed inside the cold water tank, for storing cooling water;

for said cooling-water machine, an inlet of the cooling-water machine is connected to the water pump via the water pipe, an outlet of the cooling-water machine is connected to the water jacket via the water pipe, for keeping the food material in the hopper at a low temperature; and

said water pipes are used for the communication between the water pump, the cold water tank, the cooling-water machine and the water jacket.

According to an embodiment of the 3D food printer of the present invention, said conveying system comprises a second stepper motor, a take-up roll, a cling film roll, supports, a tray, a substrate and a platform, wherein:

for said second stepper motor, an output shaft of the second stepper motor is connected to a spindle of the take-up roll, and a bed of the second stepper motor is connected to the platform, for driving the take-up roll;

for said take-up roll, the two end faces of the spindle of the take-up roll are supported on the platform by the supports, an end socket of the spindle is connected to an output shaft of the second stepper motor, and an outer edge of the take-up roll is wound by a cling film pulled out of the cling film roll, for outputting printed food products;

for said cling film roll, two end faces of the spindle of the cling film roll are supported on the platform by the supports, and the cling film winding on the roll serves as a base for printing a food product;

for said supports, an upper end of one of the supports is fitted with the spindle of the cling film roll for supporting the cling film roll, and an upper end of the other support is fitted with the spindle of the take-up roll for supporting the take-up roll, and lower ends of said two supports are connected to the platform for fixing the supports;

said tray is disposed on the platform and on the right side of the take-up roll for receiving the printed food product;

for said substrate, an upper end face of the substrate is tightly attached to the cling film, and a lower end face of the substrate is connected to the platform, for supporting the printed food product; and

for said platform, an upper end face of the platform is separately connected to lower ends of the said two supports and a lower end face of the substrate for supporting the conveying system, and said platform is further connected to the drive system for moving in X-direction and Y-direction relative to the frame.

According to an embodiment of the 3D food printer of the present invention, said conveying system actuates the take-up roll by the second stepper motor, drives the cling film roll, and pulls the cling film, so that the printed food product is automatically outputted to the tray, so as to continuously print food product without the need to manually remove the product.

According to an embodiment of the 3D food printer of the present invention, during the printing, said print head only needs to move in the Z-direction layer by layer intermittently, and the X- and Y-directional motions required for printing are achieved by said conveying system.

According to an embodiment of the 3D food printer of the present invention, said frame comprises a casing and a bed, the casing being constituted by an aluminium profile and an acrylic board, so that said print head and said conveying system of the printer are resident in an isolated dust-free environment, and said bed being used for supporting the entire 3D food printer.

According to an embodiment of the 3D food printer of the present invention, said drive system comprises stepper motor for driving in X-, Y- and Z-directions and corresponding transmission devices, for achieving the X-, Y- and Z-directional motions; and said control system consists of a computer numerical control system, for controlling the operation of the entire 3D food printer.

According to an embodiment of the 3D food printer of the present invention, said food is chocolate.

With respect to the prior art, the present invention has the beneficial effects as follows: the solution of the present invention adopts a large hopper in the print head with a cooling system, so as to store and supply a large amount of a food material (for example, a chocolate material) and print reliably at a high ambient temperature, and an automatic conveying system for printed products, so as to automatically output the food product after printing it, and then proceed with the next one. These features make the printer more effective, easier to operate, and in line with the requirements of food hygiene.

### BRIEF DESCRIPTION OF THE DRAWINGS

FIG. 1 shows a diagram of a preferred embodiment of a 3D food printer of the present invention.

### DETAILED DESCRIPTION

After reading the detail description of the embodiments of the present disclosure in conjunction with the following drawings, the above-mentioned features and advantages of the present invention can be better understood. In the drawings, the components are not necessarily drawn to scale, and the components with similar related characteristics or features may have the same or similar reference numerals.

The 3D food printer of the present invention may be used for 3D printing of food products with food materials, and a common application is for 3D printing of a chocolate product with a chocolate material. The following embodiment is explained with chocolate as an example.

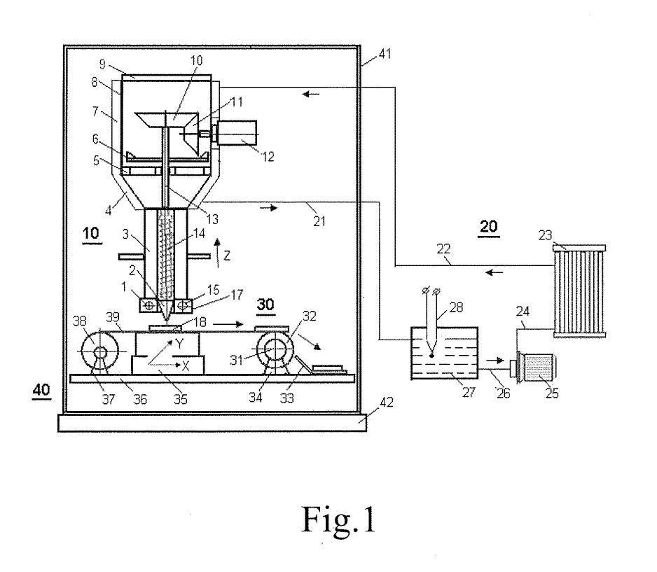

FIG. 1 shows a diagram of an embodiment of a 3D chocolate printer of the present invention. With reference to FIG. 1, the 3D chocolate printer of this embodiment mainly comprises a print head 100, a cooling system 200, a conveying system 300, a frame 400, a drive system and a control system (not shown).

The print head 100 extrudes a chocolate material, and comprises a stepper motor 12, a bevel gear pair (constituted by a large bevel gear 10 and a small bevel gear 11), a transmission shaft 13, a screw 14, a hopper 8, a material barrel 3, a material cover 9, an electric heating jacket 17, a cross-shaped plate 5, a blade 6, a water jacket 7 and a nozzle 2. The stepper motor 12 is horizontally installed on a side of the hopper 8; an output shaft of the stepper motor 12 is connected to the small bevel gear 11 in the bevel gear pair; and the base of the stepper motor 12 is connected to a side of the hopper 8. An upper end of the screw 14 is connected to the transmission shaft 13; a lower end of the screw 14 is connected to the nozzle 2; the outer diameter of the screw 14 is fitted with an inner hole of the material barrel 3, for conveying and extruding the chocolate material. The small bevel gear 11 is engaged with the large bevel gear 10, and the large bevel gear 10 is fixed to the upper end of the transmission shaft 13, for transferring the motion of the stepper motor 12. The stepper motor 12 drives the vertically installed screw 14 via the small bevel gear 11, the large bevel gear 10 engaged with the small bevel gear 11, and the transmission shaft 13, so that the chocolate granules in the hopper 8 are drawn into the screw channel on the top of the screw 14 and moves downwards along the screw channel so as to prevent the stepper motor from being perpendicular to the hopper and thus blocking the channel for adding the chocolate material and reducing the storage capacity of the hopper, and then the chocolate granules are heated to a molten state by the electric heating jacket 17 and then extruded from the nozzle 2. The upper end of the nozzle 2 is connected to the screw, and the outer edge of the nozzle is fitted with an inner hole of the electric heating jacket 17, for transforming the chocolate into a molten filament and extruding them onto a cling film of the conveying system therebelow. For heating the chocolate material in the nozzle, the electric heating jacket 17 comprises an electrical heating rod 1 and a thermocouple 15, the upper end of the electric heating jacket 17 is connected to the material barrel 3, and the inner diameter of the electric heating jacket 17 is fitted with the nozzle 2. The electric heating jacket 17 uses the electrical heating rod 1 for heating, and uses the thermocouple 15 for detecting and controlling temperature. For locating the transmission shaft 13, the outer edge of the cross-shaped plate 5 is connected to the inner wall of the hopper 8, and an inner hole of the cross-shaped plate is fitted with the transmission shaft 13 by means of a bearing therein. The transmission shaft 13 is located by means of the bearing (not shown) at the center of the cross-shaped plate 5, and a plurality of cavities are provided at the periphery of the cross-shaped plate 5, and used as falling channels for the chocolate granules in the hopper 8. An inner hole of the blade 6 is connected to the transmission shaft 13, so that the chocolate granules in the hopper 8 can be stirred, fall smoothly and enter the screw channel in the top of the screw 14. The material cover 9 on the top end of the hopper 8 can be opened when adding materials. For storing the chocolate material, the upper end of the hopper 8 is fitted with the material cover 9, the lower end of the hopper 8 is connected to the material barrel 3, and a side of the hopper 8 is connected to the base of the stepper motor 12. The inner wall of the water jacket 7 is fitted with the outer wall of the hopper 8; cooling water from the cooling system circulates in the internal groove of the water jacket 7; the water jacket 7 outside the hopper 8 is used to allow the cooling water to pass through, so as to cool the chocolate granules in the hopper 8 when the ambient temperature is too high and always keep the temperature below 25° C., so that the chocolate granules do not melt or agglomerate and it is ensured that the granules can be extruded from the screw 14 and the nozzle 2. For guiding the screw 14 and transferring the Z-directional motion, the upper end of the material barrel 3 is connected to the hopper 8, the lower end is connected to the electric heating jacket 17, and the middle part is connected to a Z-directional driving mechanism of the drive system (not shown), so as to drive the print head 100 to ascend the thickness of one layer after printing one layer of chocolate cross-section and proceed with the next chocolate cross-section. Since the hopper 8 in the above-mentioned print head 100 has a tall and large cylindrical segment, the stepper motor 12 is horizontally arranged by means of a pair of bevel gears, rather than standing in the hopper 8, so as to feed materials conveniently, and be capable of storing and supplying much more chocolate material, so that the printer can continuously print many chocolate products without frequent feeding. Furthermore, since the cooling water jacket 7 is provided outside the hopper 8, the printer can print a chocolate product normally in a hot environment.

The cooling system 200 cools the hopper 8 of the print head 100 so as to keep the chocolate material at a low temperature at which the chocolate material does not melt or agglomerate, and comprises a water pump 25, a cold water tank 27, a cooling-water machine 23, and water pipes 21, 22, 24 and 26 for communication between the water pump 25, the cold water tank 27 and the cooling-water machine 23. The water pump 25 sucks water from the cold water tank 27 via the water pipe 26 and then conveys the water to the cooling-water machine 23 via the water pipe 24, and owing to the cooling effect of the cooling-water machine 23, the water temperature is decreased to the required temperature (for example, about 20° C.), and then the water flows into the water jacket 7 of the print head 100 via the water pipe 22 to cool the hopper 8, so that the chocolate material therein is always kept below 25° C. The water flowing out of the water jacket 7 flows back to the cold water tank 27 via the water pipe 21. The outlet of the cold water tank 27 is connected to the water pump 25 via the water pipe 26, the inlet of the cold water tank 27 is connected to the water jacket 7 via the water pipe 21, the thermocouple 28 inserted into the cold water tank 27 is used to detect the water temperature in the cold water tank 27, and the water in the cold water tank 27 is kept at a required constant temperature by means of the control system (not shown).

The conveying system 300 automatically outputs the printed chocolate product, and consists of a stepper motor 31, a cling film roll 38, a take-up roll 32, a tray 33, a substrate 35, a platform 36, and supports 34 and 37. For driving the take-up roll 32, the output shaft of the stepper motor 31 is connected to the spindle of the take-up roll 32, and the bed of the stepper motor 31 is connected to the platform 36. The upper end of one of the supports 37 is fitted with the spindle of the cling film roll 38 for supporting the roll, and the upper end of the other support 34 is fitted with the spindle of the take-up roll 32 for supporting the roll. The lower end of the support 37 is connected to the platform 36 for fixing the support. Two end faces of the spindle of the cling film roll 38 are supported on the platform 36 by the supports 37 and rotate relative to the support 37, and the cling film winding on the roll serves as a base for printing chocolate products. For outputting the printed chocolate product, two end faces of the spindle of the take-up roll 32 are supported on the platform 36 by the supports, the end socket of the spindle is connected to the output shaft of the stepper motor 31, and the outer edge of the take-up roll 32 is wound by a cling film pulled out of the cling film roll 38. The spindle of the take-up roll 32 is supported on the platform 36 by the support 34, and can rotate relative to the support 34. The spindle of the take-up roll 32 is connected to the output shaft of the stepper motor 31, and under the drive of the stepper motor 31, the cling film 39 can be pulled out from the cling film roll 38 and wind around the take-up roll 32. The lower end face of the substrate 35 is fixed onto the platform 36, and the upper end face is tightly attached to the lower surface of the cling film 39. Under the action of the drive system (not shown), the platform 36, the substrate 35, the stepper motor 31, the cling film roll 38, the take-up roll 32, the support 34 and the support 37 can move in the X-Y directions. Here, the upper end face of the substrate 35 is tightly attached to the cling film, and the lower end face of the substrate 35 is connected to the platform 36, for supporting the printed chocolate product. The upper end face of the platform 36 is connected to the lower ends of the two supports and the lower end face of the substrate respectively, for supporting the conveying system, and the platform 36 is further connected to the drive system, for moving in X-direction and Y-direction relative to the frame 400.

After printing a chocolate product, the stepper motor 31 rotates in the clockwise direction to drive the take-up roll 32 to drive the cling film roll 38 to pull the cling film 39, so that the cling film 39 and the chocolate product printed thereon move in the X-direction relative to the substrate 35 and then automatically fall to the tray 33 on the right side, without the need to manually remove the chocolate product, so as to continuously print the chocolate products. The tray 33 is disposed on the platform 36 and on the right side of the take-up roll 32 for receiving the printed chocolate products.

The frame 400 bears the entire 3D chocolate printer, and comprises a casing 41 and a bed 42. The casing 41 is a closed body constituted by an aluminium profile and an acrylic board, so that the print head 100 and the conveying system 300 of the 3D printer are in a dust-free environment. The bed 42 is used for supporting the entire 3D chocolate printer.

The drive system (not shown) comprises stepper motors for driving in X-direction, Y-direction and Z-direction and corresponding transmission devices, for implementing the Z-directional motion of the print head 100 and the X-Y directional motion of the conveying system 300. The print head 100 only needs to move in the Z-direction layer by layer intermittently, and does not have to perform a transverse motion, and the X- and Y-directional motions required for printing are achieved by the conveying system.

The control system (not shown) is a computer numerical control system for controlling the motion of the entire 3D chocolate printer.

Using the structure of the above embodiment of the present invention, according to a CAD model of the chocolate product, many chocolate products can be continuously printed and automatically outputted.

Not only customized chocolate products but also other customized foods can be formed by printing with flour, jelly powder, cream, etc. using the present invention mentioned above.

The previous description of the present disclosure is provided to enable any one skilled in the art to make or use the present disclosure. Various modifications to the present disclosure would all be obvious to a person skilled in the art, and the general principles defined herein can be applied to other variations without departing from the spirit or scope of the present disclosure. Thereby, the present disclosure is not intended to be limited to the examples and designs described herein, but should be granted with the widest scope consistent with the principle and novelty features disclosed herein.

1. A 3D food printer, characterized by comprising:
a print head for extruding a food material;
a cooling system for keeping the food material at a low temperature at which the food material does not melt or agglomerate;
a conveying system for automatically outputting a printed food product;
a frame for supporting the entire 3D food printer;
a drive system for driving the 3D food printer to move in the X-, Y- and Z-directions; and
a control system for controlling the operation of the entire 3D food printer.

2. The 3D food printer according to claim 1, characterized in that said print head comprises a first stepper motor, a bevel gear pair, a transmission shaft, a screw, a hopper, a material barrel, a material cover, an electric heating jacket, a cross-shaped plate, a blade, a water jacket and a nozzle, wherein:
for said first stepper motor is horizontally installed on a side of the hopper, an output shaft of the first stepper motor is connected to a small bevel gear in the bevel gear pair, and the base of the first stepper motor is connected to a side of the hopper, for driving the screw;
for said bevel gear pair comprises a small bevel gear and a large bevel gear, the small bevel gear being engaged with the large bevel gear, and the large bevel gear being fixed to an upper end of the transmission shaft, for transferring the motion of the first stepper motor;
for said screw, an upper end of the screw is connected to the transmission shaft, a lower end of the screw is connected to the nozzle, and the outer diameter of the screw is fitted with an inner hole of the material barrel, for conveying and extruding the food material;
for said hopper, an upper end of the hopper is fitted with the material cover, a lower end of the hopper is connected to the material barrel, and a side of the hopper is connected to a base of the first stepper motor, for storing the food material;
for said material barrel, an upper end of the material barrel is connected to the hopper, a lower end of the material barrel is connected to the electric heating jacket, and a middle part of the material barrel is connected to a Z-direction driving mechanism of the drive system, for guiding the screw and transferring the Z-directional motion;
for said material cover, a lower surface of the material cover is fitted with the upper end of the hopper, for closing an upper charging opening of the hopper;
for said electric heating jacket comprises an electrical heating rod and a thermocouple, an upper end of the electric heating jacket is connected to the material barrel, and an inner hole of the electric heating jacket is fitted with the nozzle, for heating the food material in the nozzle;
for said cross-shaped plate, an outer edge of the cross-shaped plate is connected to an inner wall of the hopper, and an inner hole of the cross-shaped plate is fitted with the transmission shaft by means of a bearing therein, for locating the transmission shaft;
for said blade, an inner hole of the blade is connected to the transmission shaft, for stirring the food material in the hopper;
for said water jacket, an inner wall of the water jacket is fitted with the outer wall of the hopper, cooling water from the cooling system is circulating in an internal groove in the water jacket, for lowering the temperature of the food material in the hopper; and
for said nozzle, an upper end of the nozzle is connected to the screw, an outer edge of the nozzle is fitted with the inner hole of the electric heating jacket, for transforming the food material into a molten filament and extruding the material onto a cling film of a conveying system therebelow.

3. The 3D food printer according to claim 1, characterized in that the first stepper motor in said print head drives the vertically installed screw by means of the engaged bevel gear pair, so as to prevent the first stepper motor from being perpendicular to the hopper and thus blocking the channel for adding the food material and reducing the storage capacity of the hopper.

4. The 3D food printer according to claim 3, characterized in that the hopper of said print head is cooled by a cooling system comprising a water pump, a cold water tank, a cooling-water machine and water pipes, wherein:
for said water pump, an inlet of the water pump is connected to the cold water tank via the water pipe, and an outlet of the water pump is connected to the cooling-water machine via the water pipe, so that the water in the cold water tank is cooled by the cooling-water machine and flows into the water jacket of the print head;
for said cold water tank, an outlet of the cold water tank is connected to the water pump via the water pipe, an inlet of the cold water tank is connected to the water jacket via the water pipe, and the thermocouple is installed inside the cold water tank, for storing cooling water;
for said cooling-water machine, an inlet of the cooling-water machine is connected to the water pump via the water pipe, an outlet of the cooling-water machine is connected to the water jacket via the water pipe, for keeping the food material in the hopper at a low temperature; and
said water pipes are used for the communication between the water pump, the cold water tank, the cooling-water machine and the water jacket.

5. The 3D food printer according to claim 1, characterized in that said conveying system comprises a second stepper motor, a take-up roll, a cling film roll, supports, a tray, a substrate and a platform, wherein:
for said second stepper motor, an output shaft of the second stepper motor is connected to a spindle of the take-up roll, and a bed of the second stepper motor is connected to the platform, for driving the take-up roll;
for said take-up roll, the two end faces of the spindle of the take-up roll are supported on the platform by the supports, an end socket of the spindle is connected to an output shaft of the second stepper motor, and an outer edge of the take-up roll is wound by a cling film pulled out of the cling film roll, for outputting printed food products;
for said cling film roll, two end faces of the spindle of the cling film roll are supported on the platform by the supports, and the cling film winding on the roll serves as a base for printing the food product;
for said supports, an upper end of one of the supports is fitted with the spindle of the cling film roll for supporting the cling film roll, and an upper end of the other support is fitted with the spindle of the take-up roll for supporting the take-up roll, and lower ends of said two supports are connected to the platform for fixing the supports;
for said tray is disposed on the platform and on the right side of the take-up roll for receiving the printed food product;
for said substrate, an upper end face of the substrate is tightly attached to the cling film, and a lower end face of the substrate is connected to the platform, for supporting the printed food product; and
for said platform, an upper end face of the platform is separately connected to lower ends of the said two supports and a lower end face of the substrate for supporting the conveying system, and said platform is further connected to the drive system for moving in X-direction and Y-direction relative to the frame.

6. The 3D food printer according to claim 5, characterized in that said conveying system actuates the take-up roll by the second stepper motor, drives the cling film roll, and pulls the cling film, so that the printed food product is automatically outputted to the tray, so as to continuously print food product without the need to manually remove the product.

7. The 3D food printer according to claim 1, characterized in that, during the printing, said print head only needs to move in the Z-direction layer by layer intermittently, and the X- and Y-directional motions required for printing are achieved by said conveying system.

8. The 3D food printer according to claim 1, characterized in that said frame comprises a casing and a bed, the casing being constituted by an aluminium profile and an acrylic board, so that said print head and said conveying system of the printer are resident in an isolated dust-free environment, and said bed being used for supporting the entire 3D food printer.

9. The 3D food printer according to claim 1, characterized in that said drive system comprises stepper motors for driving in X-, Y- and Z-directions and corresponding transmission devices, for achieving the X-, Y- and Z-directional motions; and said control system consists of a computer numerical control system, for controlling the operation of the entire 3D food printer.

10. The 3D food printer according to claim 1, characterized in that said food is chocolate.
